(19) United States
(12) Patent Application Publication
(10) Pub. No.: US 2005/0034937 A1
(43) Pub. Date: Feb. 17, 2005

(54) Brake, especially for wind farms

(76) Inventors: Gabor-Josef Agardy, Herford (DE); Jurn Edzards, Schloss Holte-Stukenbrock (DE)

Correspondence Address: Richard M Goldberg, Suite 419, 25 East Salem Street, Hackensack, NJ, 07601, US

(21) Appl. No.: 10/503,380

(22) PCT Filed: Jul. 23, 2002
(86) PCT No.: PCT/EP02/08175

(30) Foreign Application Priority Data
Mar. 8, 2002 (DE) 20203794.0

(51) Int. Cl. F16D 55/08

(52) U.S. Cl. 188/72.9

(57) ABSTRACT

Brake, in particular for wind power plants, including a set of brake shoes (16, 18) and an actuator (28) for the brake shoes, in which the actuator (28) acts upon a lever (24) which is pivotable in a plane in parallel with the brake shoes (16, 18) and acts upon the brake shoes (16, 18) through a transmission (22) which translates the pivotal movement into an axial movement.

The invention relates to a brake, in particular for wind power plants, comprising a set of brake shoes and an actuator for the break shoes.

Brakes for the rotor of a wind power plant or similar large equipment must be capable of producing a high braking force and therefore require a sufficiently strong actuator. Heretofore, a hydraulic actuator has been used which directly generates the engaging force for the brake shoes. The relatively large and heavy piston and cylinder unit of the hydraulic actuator is then arranged immediately behind the brake shoes. In a spacially restricted environment as for example in the engine pod of a wind power plant, it may therefore be difficult to provide sufficient space for the actuator.

Hydraulic actuators have the further disadvantage that they are relatively harmful to the environment, are expensive and require a high maintenance effort, because a suitable hydraulic fluid as well as seals and the like for sealing the hydraulic system are needed and because, for reasons of operational safety, the fill state of the hydraulic fluid must be checked from time to time. Under these aspects, it would be desirable to employ an electromechanical actuator in place of a hydraulic actuator. However, it turns out to be difficult to provide a sufficient engaging force for the brake shoes by means of an electromechanical actuator.

It is an object of the invention to provide a brake of the type indicated above, which permits more design freedom in terms of the construction and arrangement of the actuator.

This object is achieved by the feature that the actuator acts upon a lever which is pivotable in a plane in parallel with the brake shoes and acts upon the brake shoes via a transmission which translates the pivotal movement into an axial movement.

Thus, in the brake according to the invention, the actuator can be arranged laterally offset from the brake shoes, which turns out to the advantages under certain installation conditions. Since, moreover, the actuator acts upon the brake shoes via the lever and via the transmission, it is possible to substantially boost the actuating force by means of the leverage effect and the effect of the transmission, so that, accordingly, the actuator itself may be designed to be weaker. In particular, this makes it possible also to employ an electromechanical actuator.

Advantageous details of the invention are indicated in the depended claims.

The transmission is preferably formed by a spindle which is held non-rotatably and axially displaceably in a housing and carries one of the brake shoes at one of its ends and is in engagement with a threaded sleeve at the radially inner end of the lever.

For reducing the actuating resistance, the threaded sleeve may be formed by a ball lining. It is also possible to employ a planet roller threading, a planet roller-type threaded spindle or a differential roller spindle. It is further preferable to support the threaded sleeve in the housing by means of roller bearings and, in particular, to support it against the actual reaction forces that are produced when the spindle is operated, by means of an axial bearing.

The brake may optionally be designed as an active brake in which the brake shoes are brought in the braking position when the actuator is energised, or as a passive brake, such as a spring accumulator brake, in which the actuator must be energised in order to retain the brake in the non-braking position, so that the brake will automatically become active, when the power of the actuator is cut off. In the latter case, the spindle must be displaced by means of the transmission and the lever in a direction opposite to the brake shoes in order to bias the spring assembly. In a particularly preferred embodiment, the transmission is so designed that it my be mounted in the housing in reverse positions, depending on the application case, so that active and passive brakes may be constructed with the use of mostly identical components, and a simple conversion from one brake type to the other is possible.

Embodiment examples of the invention will now be explained in conjunction with the drawings in which:

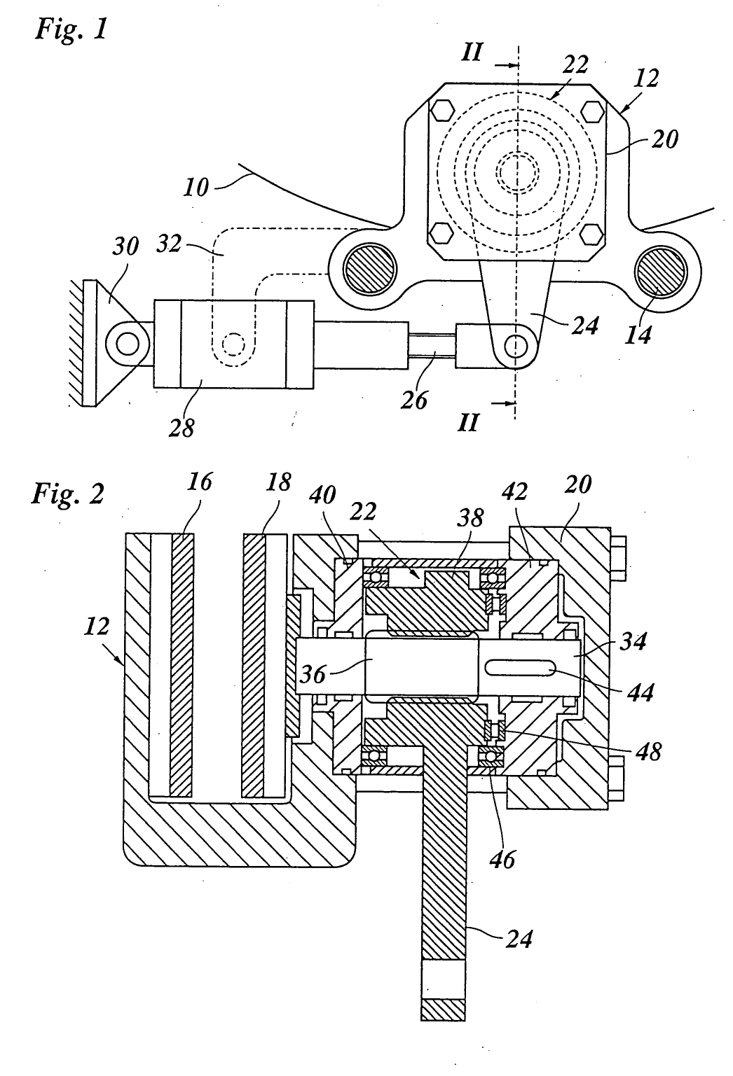

FIG. 1 is a view of a disk brake for a wind power plant;

FIG. 2 is a sectional view taken along the line II - II in FIG. 1; and

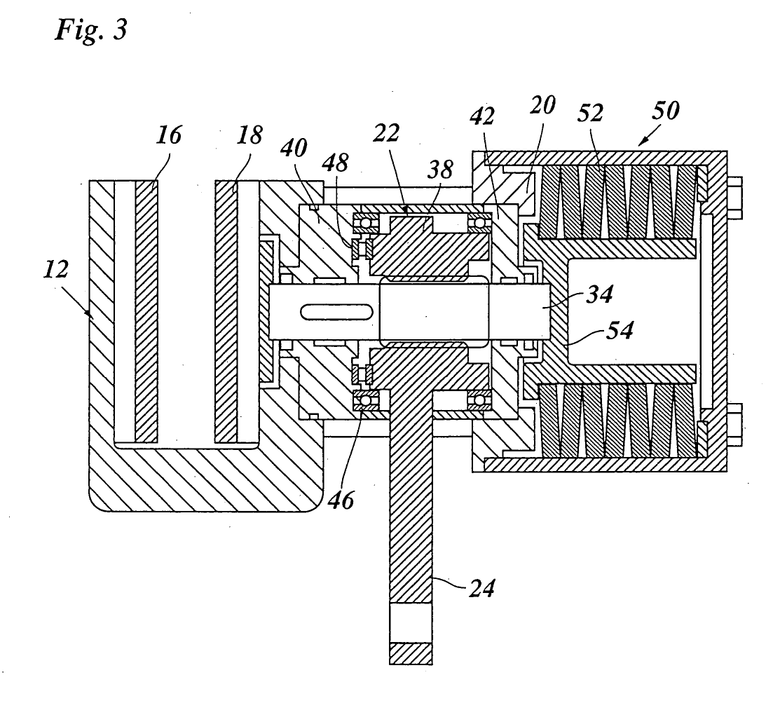

FIG. 3 is a sectional view of a spring accumulator brake.

The disk brake shown in FIGS. 1 and 2 has a floating calliper 12 which is arranged at the rim of a brake disk 10 and is slideably guided on guide bars 14 extending in parallel with the axis of the brake disk 10, and which straddles the brake disk with two brake shoes 16, 18, as is shown in FIG. 2. Mounted to the floating calliper 12 is a housing 20 which accommodates a transmission 22, with a lever 24 projecting out of the housing, said lever being pivotable about the axis of the transmission 22 in a plane that is parallel to the brake disk 10 and the brake shoes 16, 18.

The free end of the lever 24 is articulated to an actuator rod 26 of an electromechanical actuator 28. In the example shown, the actuator 28 is articulated to a support 30, that is secured to a frame of the wind power plant. As an alternative, the actuator 28 might also be secured to the calliper 12 by means of a bracket 32, as is shown in phantom lines in FIG. 1.

In the example shown, the transmission 22 is formed by a spindle 34 which carries, in its central portion, a threading 36, e. g. a ball threading, and is engagement with a threaded sleeve 38, e. g. a ball lining that is arranged at the inner end of the lever 24. The end portions of the spindle 34 situated on either side of the threading 36 are slideably guided in slide bearings 40, 42 and have keys 44 with which the spindle is secured against rotation. The threaded sleeve 38 is rotatably supported in the housing 20 by means of radial roller bearings 46. On a side facing away from the brake shoes 16, 18, it is additionally supported in the transmission housing by an axial bearing 48.

The end of the spindle 34 shown on the left side in FIG. 1 is connected to the movable brake shoe 18. When, by means of the actuator 28, the lever 24 is pivoted about the axis of the spindle 34, the spindle 34 is displaced towards the left in FIG. 2, and the brake shoes 16, 18 are evenly pressed against the brake disk. The reaction forces which then act upon the threaded sleeve 38 are absorbed by the axial bearing 48.

In the example shown, the actuator 28 is reversible, and the brake is disengaged by extending the actuator rod 26 by means of the actuator, so that the lever 24 is returned to the original position.

FIG. 3 shows a modified embodiment of the brake which, in this case, is configured as a spring accumulator brake. A spring accumulator 50 having a spring assembly 52 is mounted to the side of the transmission housing 20 facing away from the calliper 12. Here, the transmission 22 is mounted in the housing 20 in an inverted position, so that the axial bearing 48 is disposed on the side facing the brake shoes 16, 18. The actuator, which has not been shown in FIG. 3, is energised when the brake is inactive, and retains the spindle 34 in a position shifted towards the right, in which position it engages the spring assembly 52 with a shifter 54 and holds it in the compressed state. When the actuator 28 is switched off (or is de-energised in case of power blackout), the movable brake shoe 18 is shifted towards the right into the breaking position by the compressed spring assembly 52 and via the shifter 54 and the spindle 34. In this case, the transmission 22 must not be self-locking, in order for the lever 24 to be pivotable by the force of the spring assembly 52 alone.

In both embodiments, an additional catch or locking system may be provided for the lever 24 and/or the actuator 28, so that the brake may be locked in the active or inactive position or in both positions, even when the actuator is not energised permanently.

Further, is may be useful that the lever 24 is made elastic or is elastically coupled to the threaded sleeve 38, e. g. by means of a overrunning spring, so that the action of the actuator is dampened and/or a reliable engagement of the locking system in the locking position is assured.

1. Brake, for wind power plants, comprising:
a set of brake shoes,
a lever which is pivotable in a plane in parallel with the brake shoes,
a transmission which acts upon the brake shoes and which translates the pivotal movement of the lever into an axial movement, and
an actuator for causing the lever to pivot in said plane.

2. Brake according to claim 1, wherein the transmission is a spindle-type transmission.

3. Brake according to claim 2, wherein the transmission is a ball-type spindle transmission.

4. Brake according to claim 2, wherein the transmission has a spindle with a planetary ball threading.

5. Brake according to claim 2, wherein:
the lever includes a threaded sleeve, and
the transmission comprises a spindle which is non-rotatably and axially displaceably guided in a housing, has one end acting upon one of the brake shoes and is in threaded engagement with the threaded sleeve.

6. Brake according to claim 5, wherein the threaded sleeve is supported in the housing with ball bearings.

7. Brake according to claim 5, wherein the threaded sleeve has at least one axial end supported at the housing via an axial bearing.

8. Brake according to claim 1,
wherein the brake is configured as a spring accumulator brake, and
further comprising a spring assembly for biasing the transmission to act upon the brake shoes, and wherein the transmission biases the spring assembly when the actuator is active, and permits a force of the spring assembly to act upon the brake shoes when the lever is released.

9. Brake according claim 1, wherein the transmission is adapted to be mounted in a housing in an inverted position.
